(19) United States
(12) Patent Application Publication
(10) Pub. No.: US 2017/0307246 A1
(43) Pub. Date: Oct. 26, 2017

(54) MAINTENANCE SYSTEM AND MAINTENANCE METHOD OF AIR CONDITIONER

(71) Applicant: Johnson Controls-Hitachi Air Condictioning Technology (Honh Kong) Limited, HONG KONG (CN)

(72) Inventors: Takatoshi OHARA, Tokyo (JP); Emi SAITO, Tokyo (JP); Toru FUJIHIRA, Tokyo (JP); Naoya SUGIYAMA, Tokyo (JP); Katsuya MIYATA, Tokyo (JP); Toshiyuki NEMOTO, Tokyo (JP); Kouichirou SAKURAI, Tokyo (JP)

(21) Appl. No.: 15/531,809

(22) PCT Filed: Jan. 7, 2016
(86) PCT No.: PCT/JP2016/050367

§ 371 Date: May 31, 2017

(30) Foreign Application Priority Data
Jan. 22, 2015 (JP) 2015-010245

(51) Int. Cl. F24F 11/00; B23P 15/26

(52) U.S. Cl. CPC F24F 11/0086; B23P 15/26; F24F 2011/0071

(57) ABSTRACT

In order to determine configuration information of an air conditioner, to display a cause of a malfunction of the air conditioner during a trial operation and maintenance, and to easily check, on the mobile terminal, repair work based on determination results, a maintenance system of the air conditioner includes a display device that displays configuration information, a cause of a malfunction, and a repair work procedure of the air conditioner in which an outdoor device provided with an outdoor heat exchanger and an indoor device provided with an indoor heat exchanger are connected via refrigerant piping and a refrigerant is circulated by a compressor, and the display device includes a control unit that determines a configuration of the outdoor device or the indoor device of the air conditioner, a control unit that determines whether or not a malfunction occurs, and a display unit that displays a repair work procedure.

### TECHNICAL FIELD

The present invention relates to a maintenance system and a maintenance method of an air conditioner that is used in a trial operation and maintenance of the air conditioner.

### BACKGROUND ART

JP-A-2013-174384 (PTL 1) is disclosed as background art in this technical field. PTL 1 discloses, as a problem, that “in a case where an indoor device is disposed in a location that is separated from a person in an air-conditioned space, it is not possible to immediately check an operating state which is displayed on the indoor device in some cases”. Means for solving the problem is disclosed as follows. “An air conditioner includes an indoor device, a display unit provided on an indoor space side of the indoor device, a calculating unit that calculates display information of an augmented reality (AR) marker displayed on the display unit, based on information on the air conditioner, and a display drive unit that generates a drive control signal which causes the AR marker corresponding to the information on the air conditioner to be displayed, based on the display information calculated in the calculating unit, and that outputs the AR marker to the display unit”.

### CITATION LIST

### Patent Literature

Patent Literature 1 (PTL 1): JP-A-2013-174384

### SUMMARY OF INVENTION

### Technical Problem

It is necessary to test an air conditioner through a trial operation after installation. In addition, it is necessary to test the air conditioner during maintenance in operation. PTL 1 discloses that it is possible to acquire unique information and an operating state of the air conditioner by using a mobile terminal such as a smart phone, but does not disclose means that determines whether the operating state is normal. In particular, in a case where there is a bug during the trial operation or maintenance, it is not possible to easily identify a cause of the malfunction and to check a repair work procedure on the mobile terminal. In addition, the air conditioner has a change in determination criteria of a malfunction depending on a configuration of the air conditioner in some cases; however, means of determination of a malfunction in consideration with configuration information is not disclosed.

According to the present invention, there is provided a maintenance system and a maintenance method of an air conditioner in which such problems in the related art described above are solved, which makes it possible to determine configuration information of the air conditioner, which makes it possible to display, on a mobile terminal, a cause of malfunction of the air conditioner during a trial operation and maintenance, and which makes it possible to easily check, on the mobile terminal, a repair work procedure based on determination results.

### Solution to Problem

In order to solve the problems described above, in the present invention, there is provided a system that performs maintenance of an air conditioner that is provided with an indoor device, an outdoor device, a control device, and a wireless adapter, the system including: a mobile terminal that intercommunicates with the wireless adapter; and a management server that is connected to the wireless adapter and the mobile terminal via a communication line. The mobile terminal transmits information related to an operating state of the air conditioner to the management server via the wireless adapter and acquires repair work procedure information of a malfunction part in an operation from the management server, and the mobile terminal transmits, to the management server, results of repair on the air conditioner that is performed, based on the acquired repair work procedure information and acquires work report information from the management server.

In addition, in order to solve the problems described above, in the present invention, there is provided a method of performing maintenance of an air conditioner that is provided with an indoor device, an outdoor device, a control device, and a wireless adapter, the method including: transmitting information related to an operating state of the air conditioner from a mobile terminal via the wireless adapter to a management server connected through a communication line; acquiring, by the mobile terminal, repair work procedure information of a malfunction part in an operation of the air conditioner from the management server that receives the information related to the operating state of the air conditioner; transmitting, from the mobile terminal to the management server, results of repair on the air conditioner that is performed, based on the repair work procedure information acquired in the mobile terminal; and acquiring, by the mobile terminal, work report information from the management server that receives the repair results of the air conditioner.

### Advantageous Effects of Invention

According to the present invention, it is possible to determine the configuration of the air conditioner. In addition, since the operation information, particularly, a cause of malfunction in the trial operation and maintenance of the air conditioner is displayed on the mobile terminal, it is possible to easily check, on the mobile terminal, a repair procedure for repairing abnormality.

Problems, configurations, and effects, in addition to those described above are to be clearly described in the following description of embodiments.

### BRIEF DESCRIPTION OF DRAWINGS

FIG. 1 is a block diagram illustrating an entire configuration of a system according to a first embodiment of the present invention.

FIG. 2 is a block diagram illustrating a refrigeration cycle system of an air conditioner according to the first embodiment of the present invention.

FIG. 3 is a functional block diagram illustrating a configuration of an outdoor device according to the first embodiment of the present invention.

FIG. 4 is a functional block diagram illustrating a configuration of an indoor device and a remote control according to the first embodiment of the present invention.

FIG. 5 is a functional block diagram illustrating a configuration of a wireless adapter according to the first embodiment of the present invention.

FIG. 6 is a functional block diagram illustrating a configuration of a mobile terminal according to the first embodiment of the present invention.

FIG. 7 is a functional block diagram illustrating a configuration of a management server according to the first embodiment of the present invention.

FIG. 8 is a sequence diagram illustrating flow of processes between devices according to the first embodiment of the present invention.

FIG. 9 is a flowchart illustrating flow of processes performed when an automatic determination process is performed in Step S812 according to the first embodiment of the present invention.

FIG. 10 is a flowchart illustrating flow of processes performed when repair work procedure generation is performed in Step S818 according to the first embodiment of the present invention.

FIG. 11 is a table illustrating an example of a malfunction information database that is stored in a storage unit 905 according to the first embodiment of the present invention.

FIG. 12 is a table illustrating an example of repair work procedure information that is stored in a storage unit 506 according to the first embodiment of the present invention.

FIG. 13A is a diagram schematically illustrating a state in which the air conditioner is imaged by a camera of the mobile terminal so as to acquire configuration information in Step S801 according to the first embodiment of the present invention.

FIG. 13B is a front view of a mobile-terminal display unit illustrating an example of a TOP screen displayed on the display unit of the mobile terminal according to the first embodiment of the present invention.

FIG. 13C is a front view of the mobile-terminal display unit illustrating an example of a screen of displaying configuration information and an image of the air conditioner obtained through imaging according to the first embodiment of the present invention.

FIG. 13D is a front view of the mobile-terminal display unit illustrating an example of a screen of displaying both an image of the air conditioner obtained through imaging and malfunction analysis results according to the first embodiment of the present invention.

FIG. 13E is a front view of the mobile-terminal display unit illustrating an example of a screen of displaying both an image of the air conditioner obtained through imaging and a procedure 1 of work instruction according to the first embodiment of the present invention.

FIG. 13F is a front view of the mobile-terminal display unit illustrating an example of a screen of displaying both an image of the air conditioner obtained through imaging and a procedure 2 of work instruction according to the first embodiment of the present invention.

FIG. 13G is a front view of the mobile-terminal display unit illustrating an example of a screen of displaying both an image of the air conditioner obtained through imaging and a procedure 2 of work instruction according to the first embodiment of the present invention.

FIG. 13H is a front view of the mobile-terminal display unit illustrating an example of a report representing results of the repair work displayed on the display unit of the mobile terminal according to the first embodiment of the present invention.

FIG. 14 is a table illustrating an example of operation information that is stored in the storage unit 506 according to the first embodiment of the present invention.

FIG. 15 is a table illustrating an example of configuration information that is stored in the storage unit 506 according to the first embodiment of the present invention.

FIG. 16 is a table illustrating an example of malfunction determination results that are stored in the storage unit 506 according to the first embodiment of the present invention.

FIG. 17 is a functional block diagram illustrating a configuration of a mobile terminal according to a second embodiment of the present invention.

### DESCRIPTION OF EMBODIMENTS

According to the present invention, there is provided a maintenance system and a maintenance method that performs maintenance of an air conditioner that is provided with an indoor device, an outdoor device, a control device, and a wireless adapter, the system and method including: a mobile terminal that intercommunicates with the wireless adapter; and a management server that is connected to the wireless adapter and the mobile terminal via a communication line. It is possible to transmit information related to an operating state of the air conditioner from the mobile terminal to the management server via the wireless adapter and, it is possible to acquire, in the mobile terminal, as repair work procedure information of a malfunction part in an operation of the air conditioner, information containing computer graphics (CG) from the management server that receives the information related to the operating state of the air conditioner. Then, it is possible to transmit, to the management server from the mobile terminal, results of repair on the air conditioner that is performed, based on the repair work procedure information acquired in the mobile terminal, and it is possible to acquire work report information in the mobile terminal from the management server that receives the repair results of the air conditioner.

Hereinafter, Examples of the present invention will be described with reference to the figures. Here, the present invention is not construed to be limited to the following description of embodiments. It is easily understood that it is possible for those skilled in the art to modify such a specific configuration within a range without departing from an idea and a gist of the present invention.

In a configuration of the invention in the following description, the same reference signs are commonly assigned to the same components or component having the same functions in different figures, and repeated description thereof is omitted. In a case where there are a plurality of components having the same functions, alphabet such as a or b, or a hyphen and a number are added to the same reference sign in some cases for discerning. In addition, in a case where it is not necessary to discern the sign, a or b is omitted at the end of the signs in some cases.

Words of “First”, “second”, “third”, and the like in the specification are assigned to discern configurational components, and the number or order is not necessarily limited thereto.

Positions, sizes, shapes, ranges, or the like of configurations illustrated in figures or the like are not coincident with actual positions, sizes, shapes, ranges, or the like in some cases, for convenience of understanding. Therefore, in the invention, the positions, sizes, shapes, ranges, or the like are not limited to those illustrated in the figures or the like.

Publications, patents, and applications cited in the specification configure a part of description as they are.

### Example 1

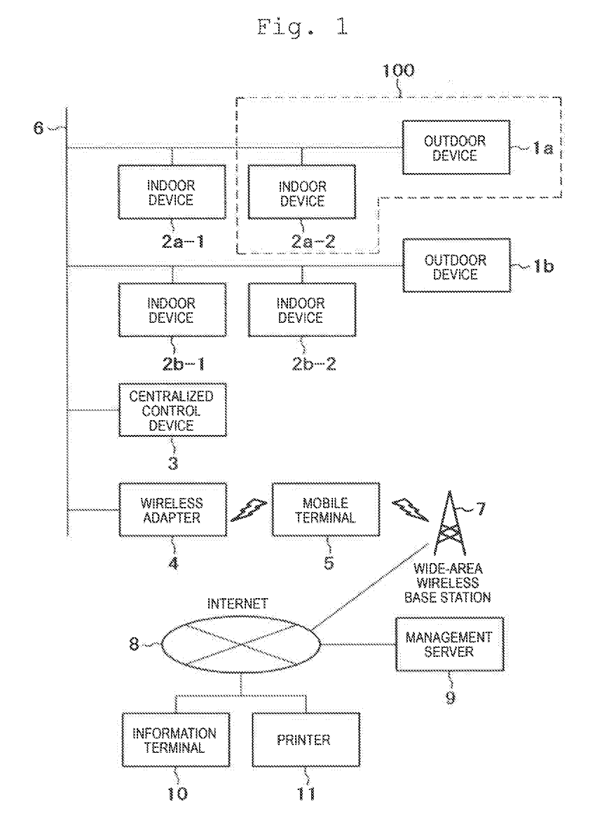

FIG. 1 illustrates a diagram of an entire air-conditioner maintenance system to which the present invention is applied. The air-conditioner maintenance system illustrated in FIG. 1 is configured to include outdoor devices 1 (1a and 1b), indoor devices 2 (2a-1, 2a-2, 2b-1, and 2b-2), a centralized control device 3, a wireless adapter 4, a mobile terminal 5, an air-conditioner communicating transmission line 6, a wide-area wireless base station 7, an internet 8, a management server 9, an information terminal 10, and a printer 11.

The outdoor device 1 and the indoor device 2 are connected to each other via refrigerant piping as will be described below and form a refrigeration cycle. In FIG. 1, the two outdoor devices 1 and the four indoor devices 2 are illustrated; however, one or more of each of the devices may be provided. A remote controller is connected to the indoor device 2, but is omitted in FIG. 1.

The centralized control device 3 is connected to the outdoor devices 1 and the indoor devices 2 via the air-conditioner communicating transmission line 6 and monitors and controls the connected devices. For example, it is possible to perform operation/stop, switching between operation modes, a change in preset temperature, a change in an air-flow direction or an air volume, prohibition setting of the remote control, schedule setting, or the like on a single or a plurality of devices. In addition, it is possible to perform a state display or an alarm display of a connected device.

The wireless adapter 4 is connected to the outdoor devices 1 and the indoor devices 2 via the air-conditioner communicating transmission line 6. In addition, the wireless adapter 4 exchanges data with the mobile terminal 5 through wireless communication. Examples of wireless communication methods include WiFi (registered trademark), Bluetooth (registered trademark), or Zigbee (registered trademark). Note that a configuration in which a wireless access point (wireless base station) is provided between the wireless adapter 4 and the mobile terminal 5 may be employed. The wireless adapter 4 transmits current operation information of the outdoor devices 1 and the indoor devices 2 to the mobile terminal 5 in response to an instruction of the mobile terminal 5, or controls the outdoor devices 1 and the indoor devices 2.

Examples of the mobile terminal 5 include any one of a mobile phone, a smart phone, a tablet type terminal, a notebook PC, a wearable device, or a device similar thereto.

The mobile terminal 5 is further able to connect to the internet 8 via the wide-area wireless base station 7. Examples of wireless communication methods include 3rd Generation (3G), LTE (registered trademark), or WiMAX (registered trademark). Note that a communication method of the mobile terminal 5 is not limited to the wireless communication method, and a wired communication method may also be used. Note that the communication method is not limited thereto, and a communication method using visible light communication, ultrasonic communication, or the like may be employed. In other words, another communication method having characteristics of being capable of transmitting information through communicating signals regardless of a transmission path may be employed.

The management server 9 is connected to the internet 8 and exchanges data with the mobile terminal 5. The management server 9 stores connection information or the like of the air conditioner that is transmitted from the mobile terminal 5. In addition, the management server 9 stores a database for each model of air conditioner, a database of malfunction information, and a repair work procedure database, and transmits the database to the mobile terminal 5 in response to an instruction of the mobile terminal 5.

The information terminal 10 is connected to the internet 8 and is capable of communicating with the management server 9. By using the information terminal 10, it is possible to refer to or update the connection information of the air conditioner that is stored in the management server 9 or the database for each model of air conditioner.

The printer 11 is connected to the internet 8 and is capable of communicating with the mobile terminal 5 or the information terminal 10. In response to the instruction of the mobile terminal 5, it is possible to output content displayed on the mobile terminal 5 to the printer 11. Note that the air-conditioner maintenance system may include a ventilation device.

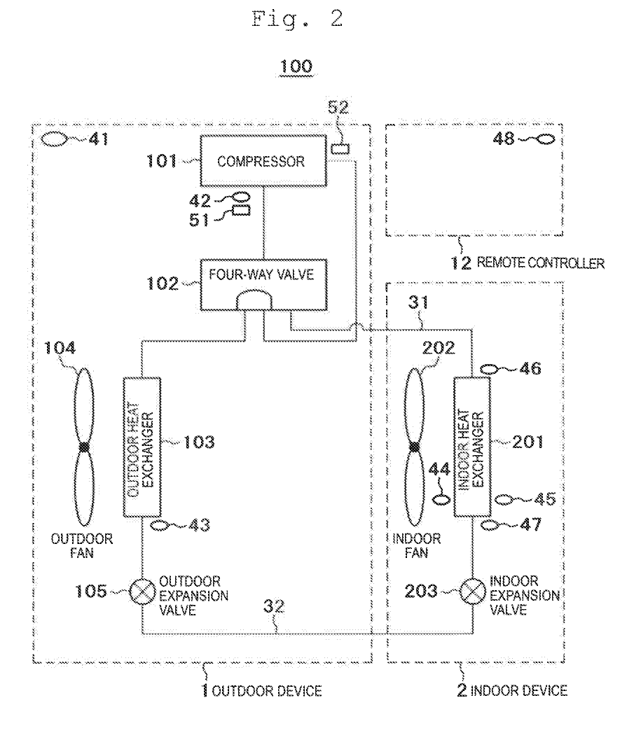

FIG. 2 illustrates a diagram of a refrigeration cycle system of the air conditioner according to the present invention. The outdoor device 1 and the indoor device 2 are connected to each other via gas piping 31 and liquid piping 32. Hereinafter, a combination of the outdoor device 1 and the indoor device 2 is referred to as an air conditioner 100. The outdoor device 1 includes a compressor 101, a four-way valve 102, an outdoor heat exchanger 103, an outdoor fan 104, and an outdoor expansion valve 105. The compressor 101 is a scroll compressor, a screw compressor, or the like, compresses a refrigerant, and discharges a high-pressure gas. The four-way valve 102 switches, depending on whether to guide refrigerant gas discharged from the compressor 101 to the outdoor heat exchanger 103 or to the indoor heat exchanger 201, thereby switching between a cooling operation and a heating operation. The outdoor fan 104 is disposed to perform ventilation of the outdoor air to the outdoor heat exchanger 103, and the outdoor heat exchanger 103 performs heat exchange between the outdoor air from the outdoor fan 104 and the refrigerant flowing inside. The outdoor expansion valve 105 is configured of an electronic expansion valve or the like and reduces pressure of the refrigerant.

In addition, the outdoor device 1 includes an outside-air temperature sensor 41, a compressor-discharge-gas-piping temperature sensor 42, a heat-exchanger-piping temperature sensor 43, a high-pressure sensor 51, and a low-pressure sensor 52. The outside-air temperature sensor 41 measures a temperature of the outside air of the outdoor device 1. The compressor-discharge-gas-piping temperature sensor 42 measures a temperature of discharge gas piping of the compressor 101. The heat-exchanger-piping temperature sensor 43 measures a temperature of the outdoor heat exchanger 103 on the liquid piping 32 side. The high-pressure sensor 51 measures pressure of discharge gas of the compressor 101. The low-pressure sensor 52 measures pressure of inlet gas of the compressor 101.

The indoor device 2 includes an indoor heat exchanger 201, an indoor fan 202, and an indoor expansion valve 203. The indoor fan 202 is disposed to perform ventilation of the indoor air to the indoor heat exchanger 201. The indoor heat exchanger 201 performs heat exchange with the indoor air. The indoor expansion valve 203 is configured of an electronic expansion valve or the like and reduces pressure of the refrigerant.

In addition, the indoor device 2 includes an inlet temperature sensor 44, an outlet temperature sensor 45, a refrigerant-gas-piping temperature sensor 46, and a refrigerant-liquid-piping temperature sensor 47. The inlet temperature sensor 44 measures a temperature of the indoor air in an inlet of the indoor heat exchanger 201. The outlet temperature sensor 45 measures a temperature of the indoor air in an outlet of the indoor heat exchanger 201. The refrigerant-gas-piping temperature sensor 46 measures a temperature of the indoor heat exchanger 201 on the gas piping 31 side. The refrigerant-liquid-piping temperature sensor 47 measures a temperature of the indoor heat exchanger 201 on the liquid piping 32 side. Further, a remote controller 12 is connected to the indoor device 2. The remote controller 12 includes a remote-control temperature sensor 48. The remote-control temperature sensor 48 measures a temperature of the indoor air around the remote controller 12.

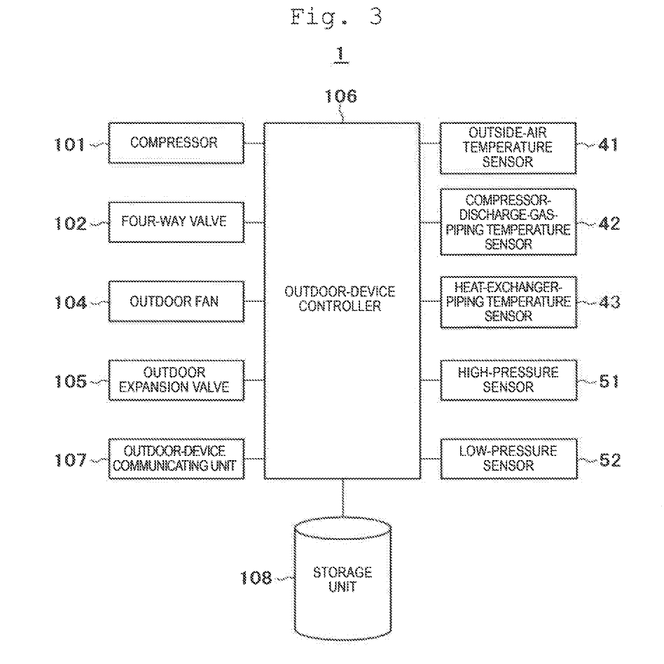

FIG. 3 illustrates a functional block diagram of the outdoor device 1 according to the present invention. An outdoor-device controller 106 provided in the outdoor device 1 controls the compressor 101, the four-way valve 102, the outdoor fan 104, the outdoor expansion valve 105, an outdoor-device communicating unit 107, and a storage unit 108. The compressor 101, the four-way valve 102, the outdoor fan 104, and the outdoor expansion valve 105 are already described. The outdoor-device controller 106 instructs an operation frequency of the compressor 101 in control of the compressor 101. In addition, the compressor 101 measures a primary voltage and a secondary voltage of an inverter inside or has a function of calculating the voltages, and the outdoor-device controller 106 reads the voltages. The outdoor-device controller 106 switches between directions of flow of the refrigerant in control of the four-way valve 102.

The outdoor-device controller 106 instructs an operation and acquires a fan operating state in control of the outdoor fan 104. The outdoor-device controller 106 switches between degrees of opening of the expansion valve in control of the outdoor expansion valve 105. The outdoor-device communicating unit 107 communicates with the indoor devices 2, the centralized control device 3, and the wireless adapter 4 via the air-conditioner communicating transmission line 6. The storage unit 108 stores a control program or various types of setting values of the outdoor device 1. In addition, the outdoor-device controller 106 is capable of reading measurement values of the outside-air temperature sensor 41, the compressor-discharge-gas-piping temperature sensor 42, the heat-exchanger-piping temperature sensor 43, the high-pressure sensor 51, and the low-pressure sensor 52.

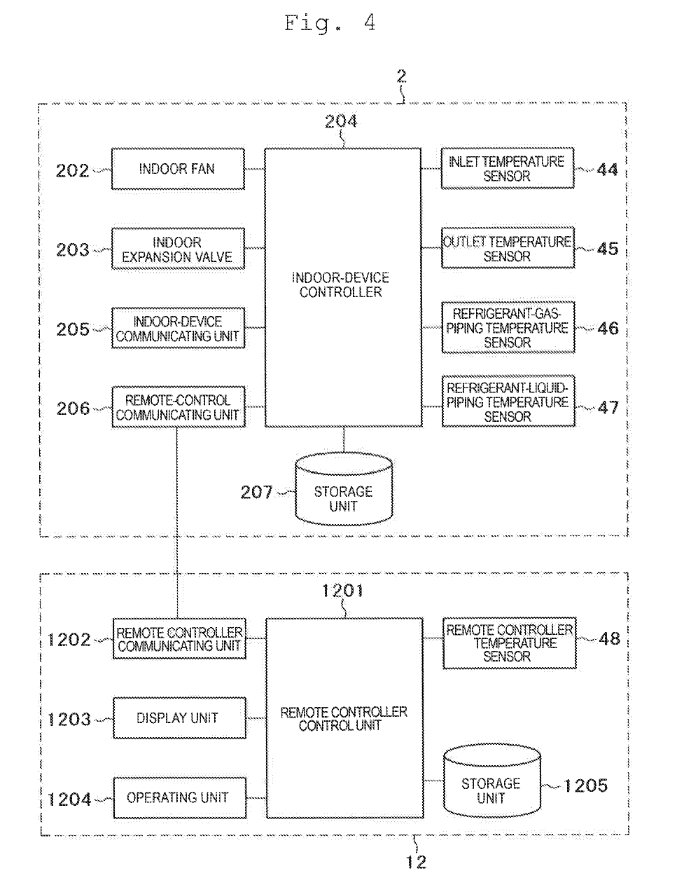

FIG. 4 illustrates a functional block diagram of the indoor device 2 and the remote controller 12 according to the present invention. An indoor-device controller 204 provided in the indoor device 2 controls the indoor fan 202, the indoor expansion valve 203, an indoor-device communicating unit 205, a remote-control communicating unit 206, and a storage unit 207. The indoor fan 202 and the indoor expansion valve 203 are already described.

The indoor-device controller 204 instructs an operation and acquires a fan operating state in control of the indoor fan 202. The indoor-device controller 204 switches between degrees of opening of the expansion valve in control of the indoor expansion valve 203. The indoor-device communicating unit 205 communicates with the outdoor devices 1, the centralized control device 3, and the wireless adapter 4 via the air-conditioner communicating transmission line 6. The remote-control communicating unit 206 communicates with the remote controller 12. The storage unit 207 stores a control program, various types of setting values, or various types of internal states of the indoor device 2. Examples of the various types of setting values include preset temperature, an operation mode, or air-volume setting. Examples of the various types of internal states include an alarm code that designates a type of abnormality when an abnormality occurs.

In addition, the indoor-device controller 204 is capable of reading measurement values of the inlet temperature sensor 44, the outlet temperature sensor 45, the refrigerant-gas-piping temperature sensor 46, and the refrigerant-liquid-piping temperature sensor 47.

A remote controller control unit 1201 provided in the remote controller 12 controls a remote controller communicating unit 1202, a display unit 1203, an operating unit 1204, and a storage unit 1205. The remote controller communicating unit 1202 communicates with the indoor device 2. The display unit 1203 is configured of a liquid crystal display (LCD), a light emitting diode (LED), or the like, and displays information related to the indoor device or the remote controller. The operating unit 1204 is configured to include buttons, switches, a touch panel, or the like, and receives input from a user. The storage unit 1205 stores a control program, various types of setting values, or various types of internal states of the remote controller 12. Examples of the various types of setting values include the preset temperature, the operation mode, or the air-volume setting. Examples of the various types of internal states include the alarm code that designates a type of abnormality when an abnormality occurs. In addition, the remote controller control unit 1201 is capable of reading measurement values of the remote-controller temperature sensor 48.

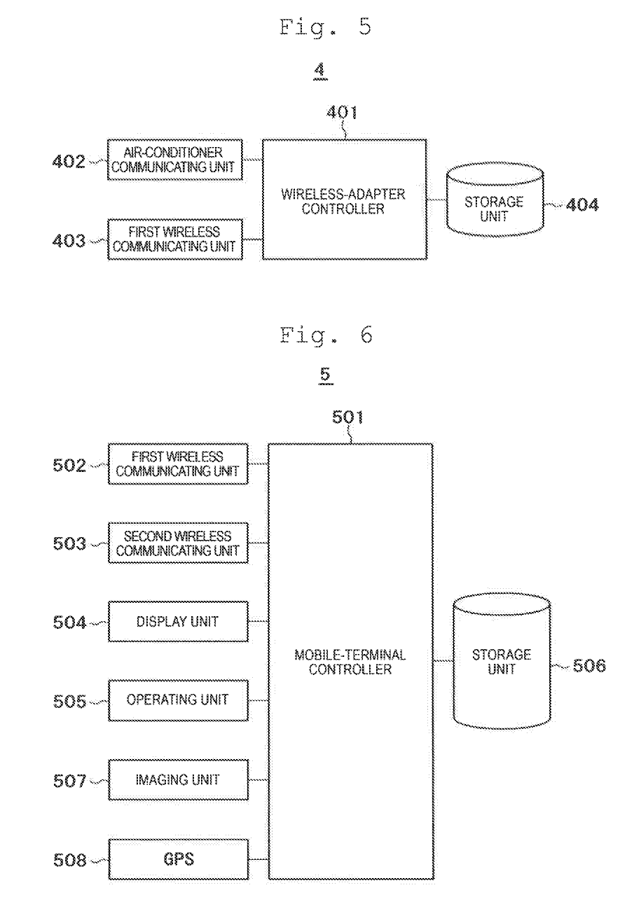

FIG. 5 illustrates a functional block diagram of the wireless adapter 4 according to the present invention. A wireless-adapter controller 401 provided in the wireless adapter 4 controls an air-conditioner communicating unit 402, a first wireless communicating unit 403, and a storage unit 404. The air-conditioner communicating unit 402 communicates with the outdoor devices 1, the indoor devices 2, and the centralized control device 3 via the air-conditioner communicating transmission line 6. The first wireless communicating unit 403 performs wireless communication with the mobile terminal 5. Examples of wireless communication methods include WiFi (registered trademark), Bluetooth (registered trademark), or Zigbee (registered trademark). The storage unit 404 stores a control program or various types of setting values of the wireless adapter 4, or current state information acquired from the outdoor devices 1 and the indoor devices 2. The wireless adapter 4 may be separately provided from the air conditioner, or may be attached to the air conditioner (the outdoor device 1, the indoor device 2, the centralized control device 3, or the like). In addition, when it is possible for the air conditioner to have a function of the wireless adapter 4, the function of the wireless adapter may be configured as a function of the air conditioner. Note that the communication method is not limited to the wireless communication method, and the wired communication method may also be used.

Note that the communication method is not limited thereto, and the communication method using the visible light communication, the ultrasonic communication, or the like may be employed. In other words, another communication method having characteristics of being capable of transmitting information through the communicating signals regardless of the transmission path may be employed.

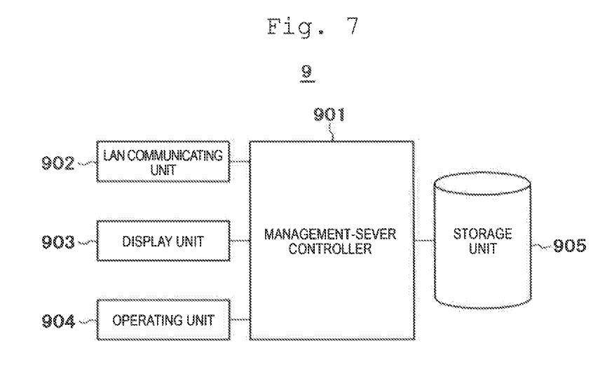

FIG. 6 illustrates a functional block diagram of the mobile terminal 5 according to the present invention. A mobile-terminal controller 501 provided in the mobile terminal 5 controls a first wireless communicating unit 502, a second wireless communicating unit 503, a display unit 504, an operating unit 505, a storage unit 506, an imaging unit 507, and a global positioning system (GPS) 508. The first wireless communicating unit 502 performs wireless communication with the wireless adapter 4. Examples of wireless communication methods include WiFi (registered trademark), Bluetooth (registered trademark), or Zigbee (registered trademark). The second wireless communicating unit 503 is connected to the internet 8 via the wide-area wireless base station 7. Examples of wireless communication methods include 3rd Generation (3G), LTE (registered trademark), or WiMAX (registered trademark). Note that the communication method is not limited to the wireless communication method, and the wired communication method may also be used.

Note that the communication method is not limited thereto, and the communication method using the visible light communication, the ultrasonic communication, or the like may be employed. In other words, another communication method having characteristics of being capable of transmitting information through the communicating signals regardless of the transmission path may be employed.

The display unit 504 is configured of the LCD, the LED, or the like, and displays various types of information. The operating unit 505 is configured to include buttons, switches, a touch panel, or the like, and receives input from a user. The imaging unit 507 is configured of a camera, acquires a still image or a video of the air conditioner 100, and identifies a model of air conditioner in the mobile-terminal controller 501. The model identification of air conditioner 100 is performed by using a QR code (registered trademark), an AR marker (registered trademark), image processing, or the like. The GPS 508 receives a radio signal that is transmitted from a GPS satellite and calculates a current position.

The storage unit 506 stores a control program or various types of setting values of the mobile terminal 5, current state information of the outdoor devices 1 and the indoor devices 2 acquired from the wireless adapter 4, or data acquired from the management server 9. The control program of the mobile terminal 5 includes an air-conditioner maintenance application that causes the mobile terminal to communicate with the wireless adapter 4 and to perform management of the air conditioner. The air-conditioner maintenance application may be preinstalled in the mobile terminal 5 or may be downloaded from the management server 9. In addition, the air-conditioner maintenance application may be executed on the management server 9, the centralized control device 3, or the wireless adapter 4. Note that the display unit 504, the operating unit 505, the storage unit 506, the imaging unit 507, and the GPS 508 may be configured as separate devices.

The imaging unit 507 may not need to be necessarily provided as long as it is possible to acquire model information of the air conditioner 100. For example, the air conditioner 100 includes an infrared communicating unit and may acquire the model information by performing infrared communication with the mobile terminal 5.

The GPS 508 may not need to be necessarily provided as long as it is possible to acquire position information of the air conditioner 100. For example, the air conditioner 100 includes the infrared communicating unit and position information and may acquire the position information by performing infrared communication with the mobile terminal 5. The information may be manually set by a user.

Note that the communication method is not limited thereto, and the communication method using the visible light communication, the ultrasonic communication, or the like may be employed. In other words, another communication method having characteristics of being capable of transmitting information through the communicating signals regardless of the transmission path may be employed.

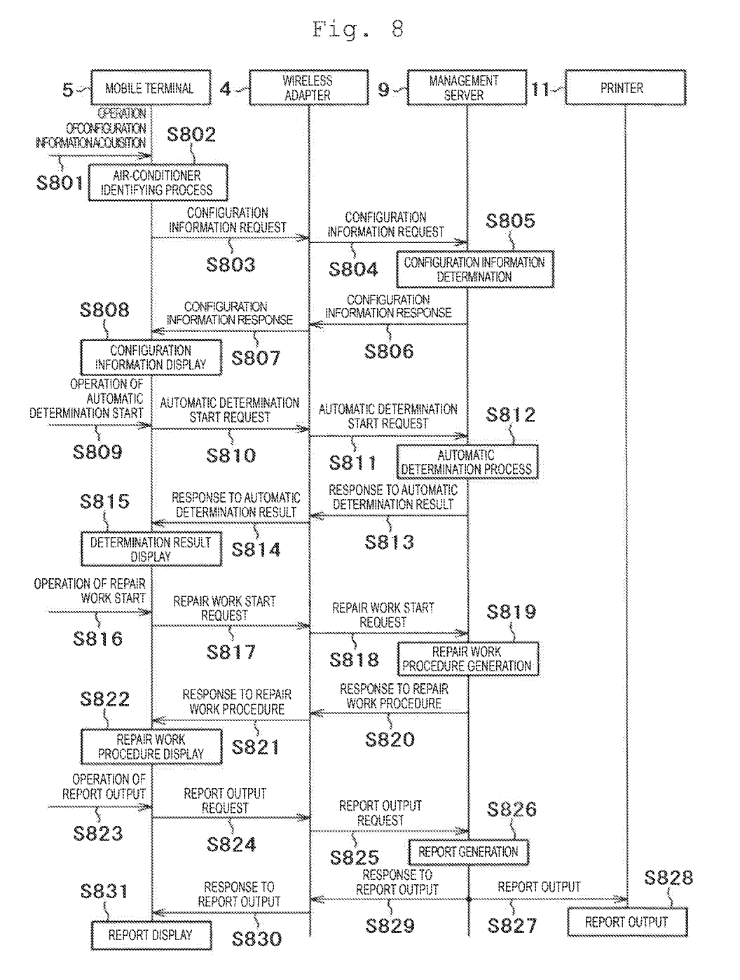

FIG. 7 illustrates a functional block diagram of the management server 9 according to the example. A management-server controller 901 (hereinafter, referred to as a controller 901) provided in the management server 9 controls a LAN communicating unit 902, a display unit 903, an operating unit 904, and a storage unit 905. The LAN communicating unit 902 is connected to the internet. The display unit 903 is configured of the LCD, the LED, or the like, and displays various types of information.

The operating unit 904 is configured to include buttons, switches, a touch panel, a keyboard, a mouse, or the like, and receives input from a user. The storage unit 905 stores a control program or various types of setting values of the management server 9 or data acquired from the mobile terminal 5. Further, the storage unit stores database related to products of the air conditioner. The database contains information of specification, a manual, malfunction check items, repair procedures, or the like of the air conditioners 100. In addition, the storage unit 905 stores a malfunction determining program and a repair procedure generating program of the operating state of the air conditioner 100. The controller 901 executes a program that is stored in the storage unit 905 by using operation information of the air conditioner 100 that is acquired from the LAN communicating unit 902, determines a malfunction, and generates a repair procedure.

Note that the display unit 903, the operating unit 904, and the storage unit 905 may be configured as separate devices. Hereinafter, when it is possible for the air conditioner 100 to have the function of the wireless adapter 4, the function of the wireless adapter may be configured as a function of the air conditioner 100.

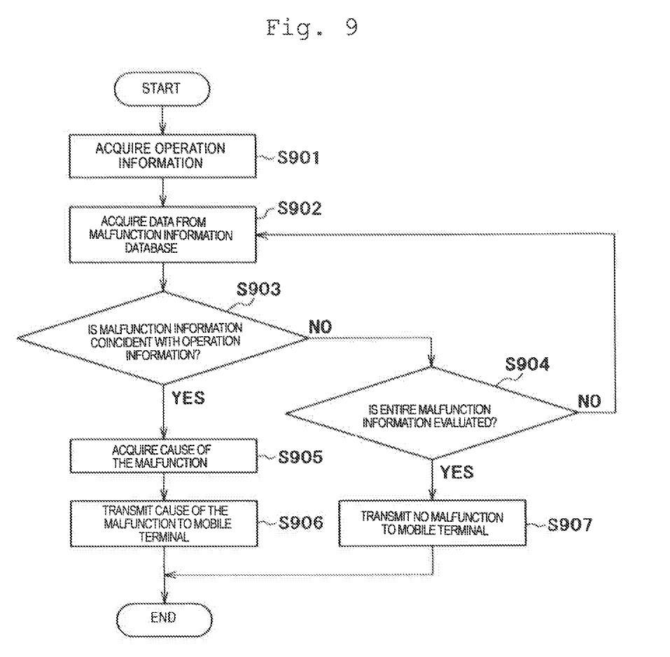

FIG. 8 illustrates an example of a sequence diagram obtained when the mobile terminal 5 communicates with the management server 9 and an automatic determination result and a repair procedure display of a malfunction of the air conditioner 100 are performed.

In the following description, communication between the mobile terminal 5 and the wireless adapter 4 or the management server 9 is performed via the first wireless communicating unit 502. An operation of the mobile terminal 5 is realized by actuating the mobile-terminal controller 501 in accordance with an air-conditioner identifying program, an operation-information automatic-determining program, a repair-work-procedure generating program, and a repair-work-result output program stored in the mobile terminal 5. In addition, the communication between the wireless adapter 4 and the air conditioner 100 (the outdoor device 1 and the indoor device 2) is performed via the air-conditioner communicating transmission line 6. In addition, only one air conditioner 100 is illustrated in FIG. 1; however, in a case where a plurality of air conditioners 100 are targets, the same communication is performed for each of the air conditioners.

A user performs, on the operating unit 505 of the mobile terminal 5, an instruction operation of configuration information acquisition of the air conditioner 100 (S801). When an image of the air conditioner 100 is acquired with the camera of the imaging unit 507 of the mobile terminal 5, the mobile-terminal controller 501 identifies a model and position information of the air conditioner 100 through an air-conditioner identifying process (S802) and the model and information are stored in the storage unit 506. In the air-conditioner identifying process (S802), the QR code (registered trademark) or the AR marker (registered trademark) disposed on the air conditioner 100 is identified through the image processing on the still image or the video of the air conditioner 100 that is acquired from the imaging unit 507. Note that without using an identification marker such as the specific AR marker, the model may be identified through the image processing or the like only on the video or the still image acquired from the imaging unit 507. In addition, the air conditioner 100 and the mobile terminal 5 include the infrared communicating unit and may acquire the model information by performing infrared communication between the corresponding infrared communicating units.

Note that the communication method is not limited thereto, and the communication method using the visible light communication, the ultrasonic communication, or the like may be employed. In other words, another communication method having characteristics of being capable of transmitting information through the communicating signals regardless of the transmission path may be employed.

The position information may be a coordinate acquired from the GPS (508) or may be input by a user. The model may be manually input by a user.

After the air-conditioner identifying process (S802) is ended, the mobile terminal 5 transmits configuration information request to the wireless adapter 4 (S803). A configuration-information request signal that is transmitted to the wireless adapter contains at least the model, position information, or the like that is identified in the air-conditioner identifying process (S802) and is stored in the storage unit 506.

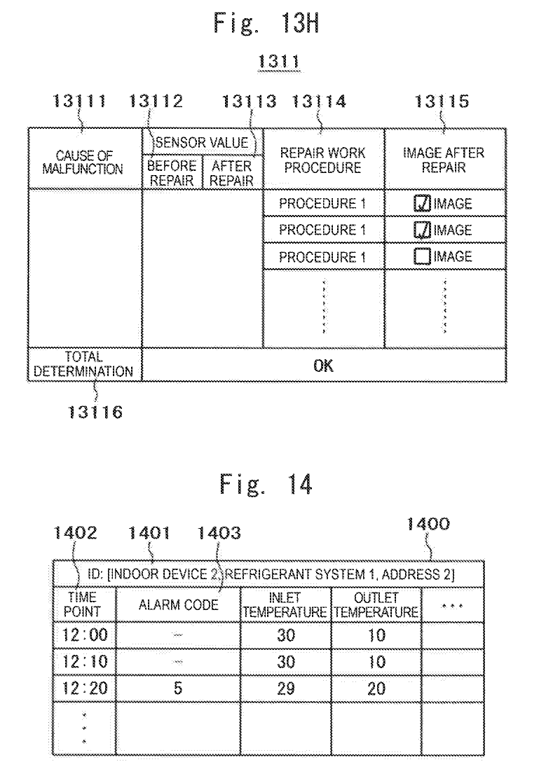

When the wireless adapter 4 receives the configuration information request from the mobile terminal 5, the configuration information request from the mobile terminal 5 is transmitted to the management server 9 via the wide-area wireless base station 7 and the internet 8 (S804). When the management server 9 receives the configuration information request, the management server starts to determine configuration information (S805). In Step S805, the model and the position contained in the air-conditioner information are compared to a configuration information table 1500 as illustrated in FIG. 15 that is stored in the management server 9, and, in a response, coincident information of the air conditioner 100 in the comparison is transmitted, as the configuration information, to the wireless adapter 4 (S806).

FIG. 15 illustrates an example of the configuration information table 1500 stored in the storage unit 905 of the management server 9. The table 1500 lists information of at least identification ID 1501 of the outdoor devices 1 and the indoor devices 2, refrigerant system (group connected via the same refrigerant piping) 1502, address (number 1503 of identifying air conditioners in the same refrigerant system), type 1504, position 1505, model 1506, piping length 1507, and piping vertical interval (vertical interval between the inlet and the outlet of piping) 1508.

When the wireless adapter 4 receives a response regarding the configuration information from the management server 9, the wireless adapter transmits a response regarding the configuration information to the mobile terminal 5 (S807). The mobile terminal 5 stores the response regarding the configuration information into the storage unit 506, and the mobile-terminal controller 501 displays the response regarding configuration information on the display unit 504 (S808).

It is possible to omit the processes from S801 to S808 by inputting data of a target air conditioner in advance.

Next, when a user performs an operation of instructing a start of automatic determination of the operation information, on the operating unit 505 of the mobile terminal 5 (S809), an automatic-determination start request signal is transmitted to the wireless adapter 4 from the mobile terminal 5 (S810). The automatic-determination start request signal transmitted from the mobile terminal 5 contains, as the operation information of the air conditioner 100 associated with the configuration information acquired in S808, anyone of at least an operation frequency, high-pressure side pressure, low-pressure side pressure, a primary current and a secondary current of an inverter, and an outside temperature of a compressor 101 of the outdoor device 1, a total of operation frequencies of a plurality of compressors, an inlet air temperature, an outlet air temperature, a temperature difference between the inlet air temperature and the outlet air temperature, preset temperature, an operation mode, and a preset air volume of the indoor device 2.

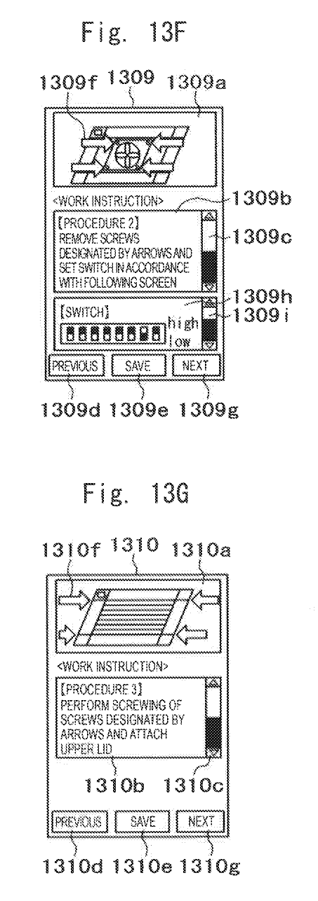

FIG. 14 illustrates an example of a table 1400 of operation information. The operation information is stored to be associated with an identifier 1401 and time-point information 1402 of the air conditioner 100 and information acquired during the trial operation and the normal operations is stored. All of such data of the operation information may not need to be stored but information that needs to be used in display or abnormality determination is stored. The identifier 1401 of the air conditioner 100 is, for example, information (ID) that is used to identify the individual outdoor devices 1 or indoor devices 2 which are connected to the system. The connection information such as the refrigerant system or the address of the air conditioner 100 may be input in advance or may be acquired from the wireless adapter 4. The time-point information 1402 may be time-point information added by the air conditioner 100 or may be a received time point of the wireless adapter 4. The ID used to identify the air conditioner may be a set of refrigerant system numbers and address numbers or may be an IP address of the air conditioner. An alarm code 1403 indicates a code corresponding to the abnormality determination result.

The data of the table 1400 in FIG. 14 is described as data stored in the storage unit 506 of the mobile terminal 5 and in the storage unit 905 of the management server 9. As another method, the data may be stored in a storage device outside the mobile terminal 5, and wired or wireless connection may be employed therebetween. In this manner, it is possible to reduce a capacity of the storage device of the mobile terminal 5. On the other hand, a display speed is slow by a period of transmission time of the data. Note that the automatic-determination start request signal may not contain the operation information, but may be stored in the storage unit 905 of the management server 9 in advance and may be used (S809).

When the wireless adapter 4 receives the automatic-determination start request from the mobile terminal 5, the wireless adapter transmits the automatic-determination start request to the management server 9 (S811).

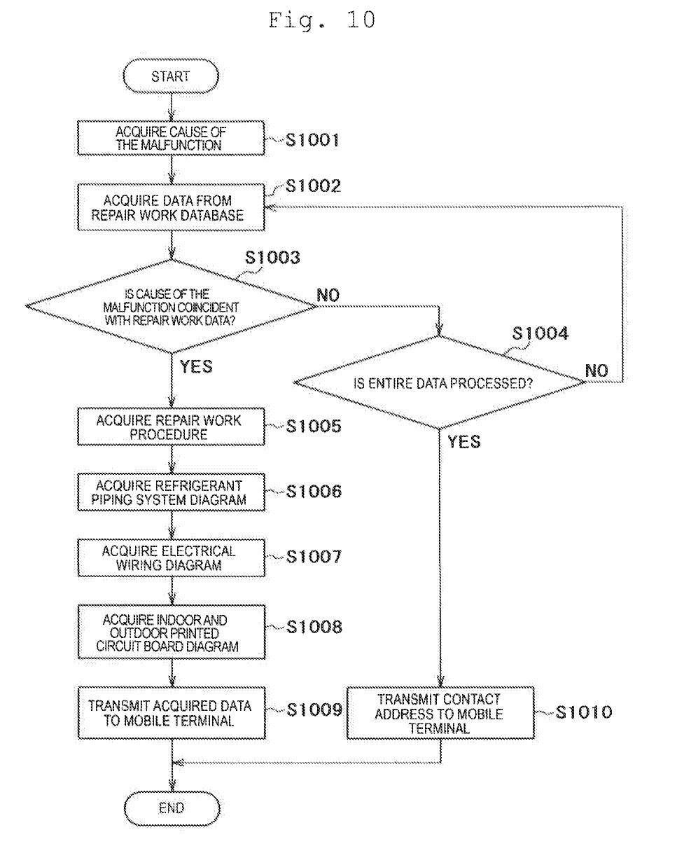

When the management server 9 receives the automatic-determination start request from the wireless adapter 4, the management server stores the operation information in the storage unit 905 and performs an automatic determination process (S812). At this time, the management server determines an occurrence of a malfunction and a cause of the malfunction, based on the operation information, stores the determination results in the storage unit 905, and transmits the determination results to the wireless adapter 4 (S813). Note that the automatic-determination start request signal that is transmitted in the steps of S810 and S811 may not contain the operation information, but may be stored in the storage unit 905 of the management server 9 in advance and may be used. Details of the automatic determination process in Step S812 are clearly described in the description with reference to FIG. 9, which will be described below.

When the wireless adapter 4 receives the automatic determination results from the management server 9, the wireless adapter transmits the automatic determination results to the mobile terminal 5 (S814).

When the mobile terminal 5 receives the automatic determination results from the wireless adapter 4, the mobile terminal 5 stores the automatic determination results in the storage unit 506 and causes the mobile-terminal controller 501 to output the automatic determination results on the display unit 504 (S815).

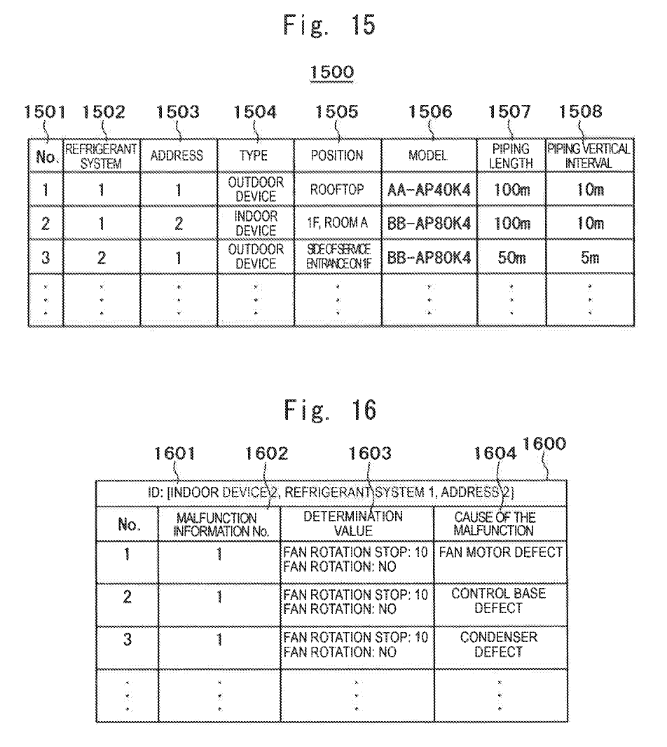

FIG. 16 illustrates an example of a determination result table 1600. The determination results are stored for each identifier 1601 of the air conditioner, and contain at least sequence number 1602 of malfunction information, determination value 1603, and cause of malfunction 1604 which are clear in Step S812. All of such data of the determination results may not need to be stored as data as long as information that needs to be used in identification and repair of the malfunction cause is stored. The identifier 1601 of the air conditioner 100 is, for example, information (ID) that is used to identify the individual outdoor devices 1 or indoor devices which are connected to the system. The connection information such as the refrigerant system or the address of the air conditioner 100 may be input in advance or may be acquired from the wireless adapter 4. The ID used to identify the air conditioner may be a set of refrigerant system numbers and address numbers or may be an IP address of the air conditioner.

The data of the determination result table 1600 in FIG. 16 is described as data stored in the storage unit 506 of the mobile terminal 5 and in the storage unit 905 of the management server 9. As another method, the data may be stored in a storage device outside the mobile terminal 5, and wired or wireless connection may be employed therebetween. In this manner, it is possible to reduce the capacity of the storage device of the mobile terminal 5. On the other hand, a display speed is slow by a period of transmission time of the data.

In a case where the malfunction information is contained in the signal of the response to the automatic determination results that is transmitted to the mobile terminal 5 from the management server 9 via the wireless adapter 4 in S813 and S814, a user performs, on the operating unit 505, an operation of the instruction of a repair work start (S816), and a signal of a repair work start request is transmitted to the wireless adapter 4 from the mobile terminal 5 (S817). When the wireless adapter 4 receives the signal of the repair work start request from the mobile terminal 5, the wireless adapter transmits the signal of the repair work start request to the management server 9 (S818). The repair work start request contains at least the malfunction determination results.

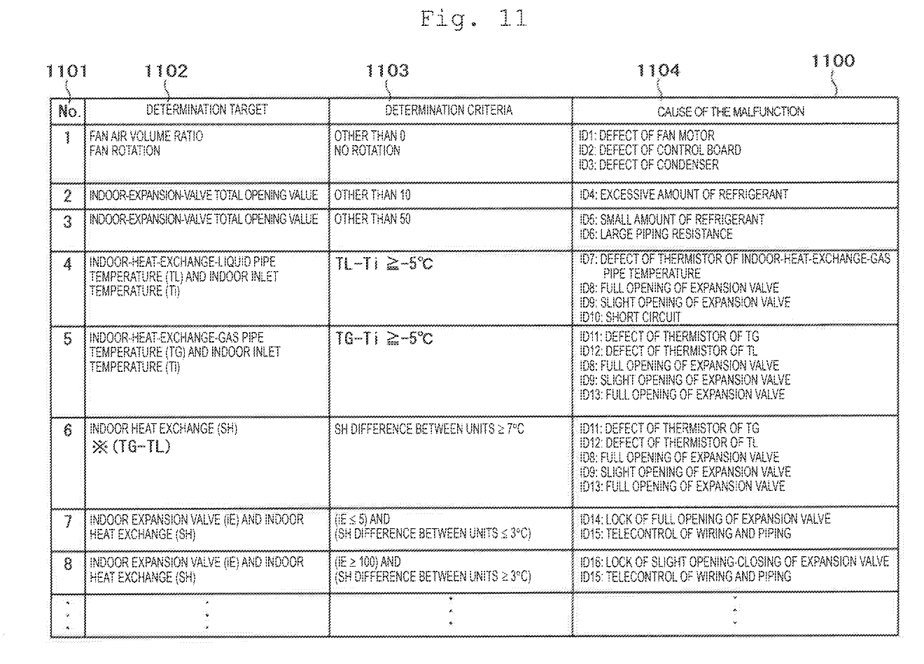

When the management server 9 receives the signal of the repair work start request from the wireless adapter 4, the management server performs a repair work procedure generating process (S819). In the repair work procedure generating process, a repair work procedure that is coincident to the malfunction information is derived from the repair work procedure information that is stored in the storage unit 905, the repair work procedure is stored in the storage unit 905, and a signal of the repair work procedure is transmitted to the wireless adapter 4 (S820). Details of the process in Step S819 are clearly described in the description with reference to FIG. 10, which will be described below.

Note that the automatic-determination start request signal (S817 and S818), which is transmitted to the management server 9 from the mobile terminal 5 via the wireless adapter in S817 and S818, may not contain the malfunction determination results, but may be stored in the storage unit 905 of the management server 9 in advance and may be used.

When the wireless adapter 4 receives a signal of the repair work procedure notification from the management server 9 in S820, the wireless adapter transmits the signal of the repair work procedure to the mobile terminal 5 (S821).

When the mobile terminal 5 receives the signal of the repair work procedure in S821, the mobile terminal stores the signal in the storage unit 506 and causes the mobile-terminal controller 501 to output the result (repair work procedure) on the display unit 504 (S822). A user performs repair work of the air conditioner 100 while following the repair work procedure which is displayed on the display unit 504. Repair work results obtained by the work of the user are stored in the storage unit 506. The repair work results obtained by the work of the user may be stored in the centralized control device 3, the wireless adapter 4, and the management server 9.

When the user ends the repair work of the air conditioner 100, and performs, on the operating unit 505, an operation of instructing report generation of the work results (S823), the mobile terminal 5 transmits a signal of a report generation request to the wireless adapter 4 (S824, and the wireless adapter 4 transmits the signal of the report generation request to the management server 9 (S825).

When the management server 9 receives the report generation request, the management server 9 performs a report generating process (S826). A signal of a report output request includes the operation information, the configuration information, the automatic determination results, and the results of the repair work.

The information of the report generated in the management server 9 in S826 is sent to the printer 11 (S827) to be printed, and output (S828), and the information is also sent to the wireless adapter 4 (S829) to be transmitted to the mobile terminal 5 from the wireless adapter 4 (S830) to be displayed on the display unit 504 of the mobile terminal 5 (S831).

Note that the sequence described above is an example, and the results of the trial operation may be used as the operation information. The operation of start of the automatic determination is not limited to the mobile terminal 5, and may be performed from another configurational device such as the centralized control device 3. In addition, the transmission of the various types of signals to the management server is also not limited to the wireless adapter 4, and may be performed from another configurational device such as the centralized control device 3. In addition, direct communication may be performed between the mobile terminal 5 and the management server 9 without the wireless adapter 4.

A communication procedure between nodes may be performed through pushing or pulling. For example, the transmission of the signal of the operation information notification from the wireless adapter 4 to the mobile terminal 5 is not limited to the pushing, and the transmission of the signal of the operation information notification from the mobile terminal 5 may be performed through the pulling.

The air-conditioner identifying process in Step S802 may not be performed in the mobile terminal 5, and may be performed in a control unit of the wireless adapter 4, the centralized control device 3, or the management server 9.

The configuration information determination in Step S805 may not be performed in the management server 9, and may be determined by the mobile terminal 5, the wireless adapter 4, or the centralized control device 3.

The steps from S823 to S831 are not necessarily required steps. For example, the steps may be executed only in a case where there is obligation to present the report of the repair work results to a third party.

As described above, it is possible for the user to find the cause of the malfunction of the air conditioner 100 and to perform repair on the mobile terminal 5. In other words, regarding the check of the operation information, using, as an operation information display device, the widely-used inexpensive mobile terminal 5 such as a smart phone, instead of a dedicated expensive device, it is possible to reduce costs for the trial operation. In addition, even in a configuration in which a plurality of outdoor devices and the indoor devices are disposed to be separated in a building, a hotel, or a tenanted facility, necessity of moving is reduced and a burden on the user is reduced as long as the target is within a communication range. In addition, a procedure of repair work does not need to be searched for each type of different air conditioners, and it is possible for an operator to reduce learning costs.

FIG. 9 illustrates an example of a flowchart obtained when the automatic determination process is performed in the management server 9 in Step S812 described with reference to FIG. 8.

In Step S901, the controller 901 of the management server acquires the operation information contained in the automatic-determination start request signal that is transmitted to the management server 9 via the wireless adapter 4 in S810 and S811 through the operation (S809) of instructing the automatic determination start of the mobile terminal 5.

Note that the operation information may be stored in the storage unit 905 of the management server 9 in advance, and may be acquired. The operation information acquired at this stage is the operation information in a range of types and a period of time in which at least a malfunction of the air conditioner 100 can be determined.

In Step S902, the controller 901 extracts a row of data from the malfunction information database that is stored in the storage unit 905.

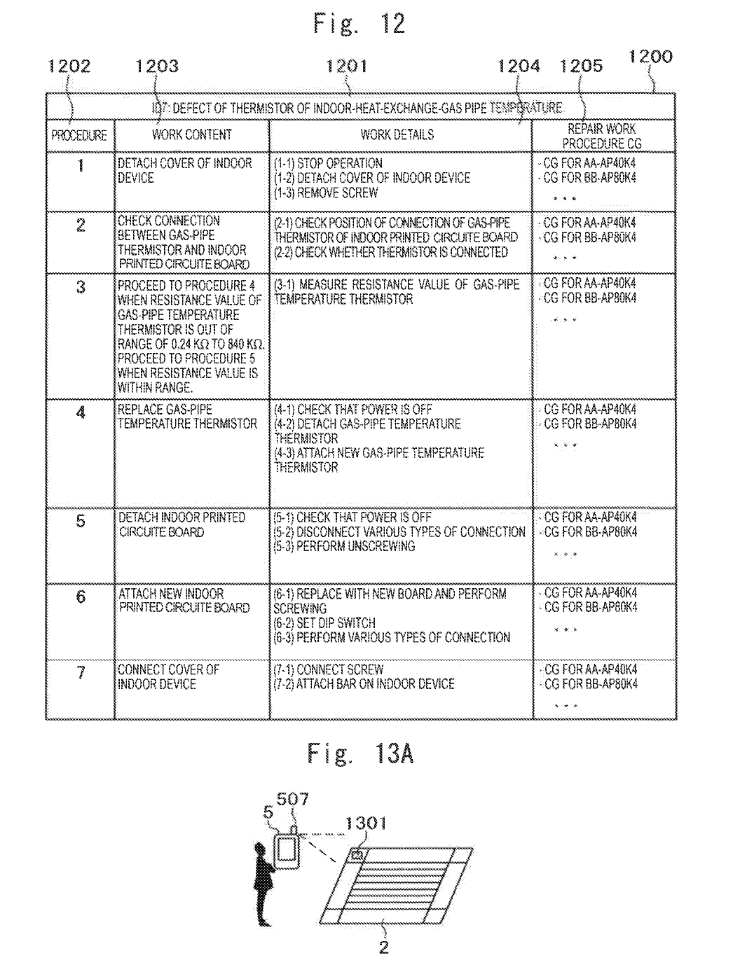

FIG. 11 illustrates an example of a table 1100 of the malfunction information database. The malfunction information database contains at least sequence numbers (written as No. in the FIG. 1101, determination targets 1102, determination criteria 1103, and cause of the malfunction 1104. Note that identification ID is set for each cause of the malfunction.

For example, the determination target 1102 is the operation information of the air conditioner as a fan air volume ratio, an indoor-expansion-valve total opening value, or the like, and is information contained in S811.

In the determination criteria 1103, determination conditions are designated with respect to the corresponding determination target. For example, in a case where the upper limit value is set, and a condition, in which measurement values exceed the corresponding upper limit value or exceed the corresponding upper limit value for a predetermined continuous period of time, is satisfied, an occurrence of the malfunction is considered.

Otherwise, in a case where the lower limit value is set, and a condition, in which measurement values are lower than the corresponding lower limit value or are lower than the corresponding lower limit value for a predetermined continuous period of time, is satisfied, an occurrence of the malfunction is considered.

Regarding the determination target 1102, in a case where the determination criteria 1103 are satisfied, the assumed malfunction is regarded as the cause of the malfunction 1104.

In Step S903, information of the determination target 1102 is extracted from the operation information acquired in Step S901, and the controller 901 determines whether the malfunction information is coincident with the operation information. In a case where the malfunction information is coincident with the operation information and the determination criteria 1103 are satisfied (a case of YES), the process proceeds to S905, and the cause of the malfunction 1104 corresponding to the determination criteria 1103 is acquired. In a case where the malfunction information is not coincident with the operation information and the determination criteria 1103 are not satisfied (a case of NO), the process proceeds to S904.

In S904, the controller 901 determines whether all of the rows of the malfunction information database are evaluated in S902 and S903.

In a case where all of the rows are evaluated (a case of YES), the process proceeds to S907. In a case where the evaluation is not completed (a case of NO), the process proceeds to the next row of the malfunction information database, returns to Step S902, and the processes to Step S903 are repeatedly performed.

In Step S905, the controller 901 acquires the cause of the malfunction 1104 from the malfunction information data and stores the cause of the malfunction in the storage unit 905.

In Step S906, the controller 901 transmits, as information of results of the automatic determination process, the cause of the malfunction, which is stored in the storage unit 905, to the wireless adapter 4 from the LAN communicating unit 902, and the information of results of the automatic determination process is transmitted to the mobile terminal 5 from the wireless adapter 4.

In a case where the entire malfunction information is evaluated and the process proceeds to Step S907, the controller 901 transmits, as the information of results of the automatic determination process, information that is not the malfunction information to the wireless adapter 4 from the LAN communicating unit 902, in Step S907, and the information of results of the automatic determination process is transmitted to the mobile terminal 5 from the wireless adapter 4.

In FIG. 9, the data is picked up in order from the first row in the database; however, the order is not limited thereto, and it is possible to use a hashing method, a binary searching method, or the like. In a case of using the hashing method, a hash value for each data of the malfunction information database is set in advance, it is possible to acquire the malfunction information that is coincident with the operation information based thereon, and it is possible to perform a high-speed search for the target.

In other words, a search characterized by searching for desirable data from the data may be used. According to the processes described above, it is possible to identify a cause of the malfunction from the operation information.

FIG. 10 illustrates an example of a flowchart obtained when the repair work procedure is generated in Step S819 in FIG. 8.

In Step S1001, the controller 901 of the management server 9 acquires the cause of the malfunction contained in the repair work start request signal that is transmitted to the management server 9 via the wireless adapter 4 in S817 and S818 through the operation (S816) of instructing the repair work start of the mobile terminal 5. Note that the cause of the malfunction may be stored in the storage unit 905 of the management server 9 in advance, and may be acquired.

In Step S1002, the controller 901 extracts a row of data from the repair work procedure database that is stored in the storage unit 905.

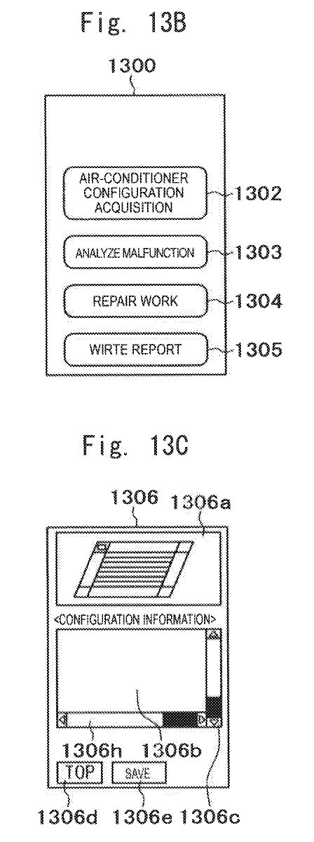

FIG. 12 illustrates an example of a table 1200 of the repair work procedure database. In the repair work procedure database, identification number (ID) 1201 of the cause of the malfunction, procedure number 1202, work content 1203, work details 1204, and repair work procedure computer graphics (CG) 1205 are stored. The identification ID 1201 of the cause of the malfunction is the same ID assigned to the cause of the malfunction 1104 stored in the table 1100 of the malfunction information database illustrated in FIG. 11, and it is possible to identify the cause of the malfunction 1104.

The repair work procedure CG 1205 is CG displayed with the corresponding work details interposed on the video acquired by the imaging unit 507 of the mobile terminal 5, and CG is stored for each type of the air conditioner 100. Note that the repair work procedure CG 1205 may not be stored for each type of the air conditioner 100, and may be generated and stored for each configuration of the air conditioner.

In Step S1003, determination is performed on whether the malfunction information identification ID 1201 of the repair work procedure data illustrated in the table 1200 of the repair work procedure database is coincident with the ID assigned to the cause of the malfunction 1104 of the table 1100 of the malfunction information database stored in the storage unit 905. In a case of being coincident (YES), the process proceeds to S1005. In a case of being incoincident (NO), the process proceeds to S1004. In S1004, the controller 901 determines whether all of the rows of the repair work database are evaluated in S1002 and S1003.

In a case where all of the rows in the repair work database are evaluated (a case of YES), the process proceeds to S1010. In a case where the evaluation is not completed (a case of NO), the process proceeds to the next row of the malfunction information database, returns to Step S1002, and the processes to Step S1003 are repeatedly performed.

In Step S1005, the controller 901 acquires a repair work procedure from the repair work procedure data illustrated in the table 1200 of the repair work procedure database and stores the procedure in the storage unit 905.

In Step S1006, the controller 901 acquires information of a diagram of the refrigerant piping system that is stored in the storage unit 404 of the wireless adapter 4 and stores the information in the storage unit 905.

In Step S1007, the controller 901 acquires information of a diagram of an electric wiring system that is stored in the storage unit 404 of the wireless adapter 4 and stores the information in the storage unit 905.

In Step S1008, the controller 901 acquires information of an outdoor printed circuit board and an indoor printed circuit board that are stored in the storage unit 404 of the wireless adapter 4 and stores the information in the storage unit 905.

In Step S1009, the controller 901 transmits, to the mobile terminal 5, the information of the repair work procedure, the information of the diagram of the refrigerant piping system, the information of the diagram of the electric wiring system, the information of the outdoor printed circuit board and the indoor printed circuit board or the like that are stored in the storage unit 404 of the wireless adapter 4.

In a case where the entire data is processed, determination is performed that the cause of the malfunction is not coincident with the repair work data in S1003, and the process proceeds to Step S1010, no information is contained in the repair work procedure database in Step S1010. Therefore, information of a telephone number of a contact address, a mail address, a homepage, or the like is transmitted to the mobile terminal 5.

In the flow illustrated in FIG. 10, the data is picked up in order from the first row in the database; however, the order is not limited thereto, and it is possible to use the hashing method, the binary searching method, or the like. In a case of using the hashing method, a hash value for each data of the repair work procedure database is set in advance, it is possible to acquire the repair work procedure that is coincident with the repair work cause based thereon, and it is possible to perform a high-speed search for the target. In other words, a search characterized by searching for desirable data from the data may be used. As described above, it is possible to generate the repair work procedure in order to eliminate the cause of the malfunction.

Hereinafter, the operation performed in a case where the indoor device 2 is a target as the air conditioner 100 will be described.

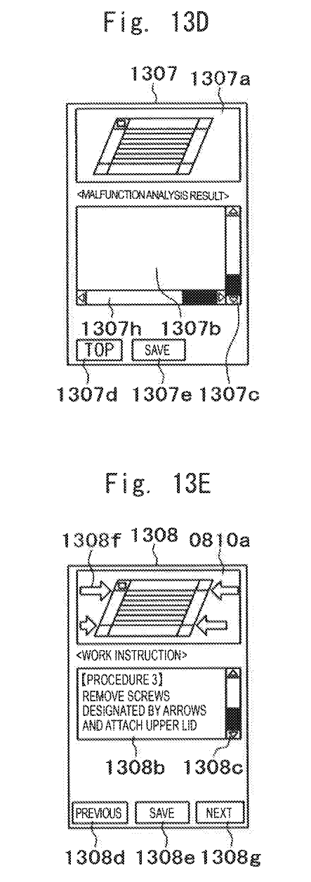

FIG. 13A illustrates a state in which an operator images, with the imaging unit 507 of the mobile terminal 5, the video or the still image of the indoor device 2 which contains an AR marker 1301 that is formed on the indoor device 2.

FIGS. 13B to 13G illustrate examples of screens that are displayed in Step S808, Step S815, and Step 822 illustrated in FIG. 8. The screens are displayed on the display unit 504 of the mobile terminal 5. As illustrated in FIG. 13B, the user performs, on the operating unit 505, operations of selecting an item which is wanted to be activated, on a TOP screen 1300 of the mobile terminal 5 on which items of air-conditioner configuration acquisition 1302 corresponding to the configuration information display in S808 in the flowchart illustrated in FIG. 8, malfunction analysis 1303 corresponding to the determination result display in S815, repair work 1304 corresponding to the repair work procedure display in S822, and report generation 1305 corresponding to the report display in S830 are displayed.

The operation signal input from the operating unit 505 is received by the mobile-terminal controller 501, and an air-conditioner maintenance program is started. The air-conditioner maintenance program is an application program that is executed by the mobile-terminal controller 501. When processing is started by a predetermined operation after the start of the program, the entire system executes a sequence illustrated in FIG. 8.

For example, when the user operates an “air-conditioner configuration acquisition” display region 1302 displayed on the display unit 504 of the mobile terminal 5 (the air-conditioner configuration acquisition 1302 displayed on the display unit 504 is touched by finger), the mobile-terminal controller 501 performs control such that the screen displayed on the display unit 504 is subjected to transition to a screen 1306 as illustrated in FIG. 13C.

On the screen 1306, the user displays, in an imaging result display region 1306a, the video and a still image of the indoor device 2 that is acquired by using the imaging unit 507 of the mobile terminal 5 as illustrated in FIG. 13A, and controls the display unit 504 such that configuration information determined by the management server 9 in S805 in the flow in FIG. 8 is displayed in the “configuration information” display region 1306b.

When the user operates, on the operating unit 505, a “TOP” display region 1306d on the screen 1306, the mobile-terminal controller 501 performs control such that the display unit 504 returns to the screen 1300.

When the user operates, on the operating unit 505, a “save” display region 1306e on the screen 1306, the mobile-terminal controller 501 generates a still image of a screen that is displayed in the imaging result display region 1306a of the screen 1306, and the mobile-terminal controller 501 causes the storage unit 506 to store the still image. At the same time, the acquired configuration information is stored in the storage unit 506.

The imaging result display region 1306a is controlled by the mobile-terminal controller 501 such that the video and the still image of the indoor device 2 acquired by the imaging unit 507 of the mobile terminal 5 are displayed on the display unit 504. The indoor device 2 of the air conditioner 100, as the imaging target, includes the AR marker 1301 (registered trademark), and the mobile-terminal controller 501 identifies the AR marker (registered trademark) from the acquired video and still image, and the information of a model or the like is acquired. Here, the AR marker (registered trademark) is used for identification of the air conditioner 100; however, the QR code (registered trademark) may be used.

The configuration information of the indoor device 2 acquired from the storage unit 905 of the management server 9 in S805 is displayed to have a table format on a configuration information display unit 1306b in FIG. 13C. In the case of the mobile terminal 5, since it is possible for the user to arbitrarily change a posture of the device, vertical and horizontal are relative concepts and can be interchanged. In the specification, a horizontal direction in a view from the user is defined to be a vertical(x) direction.

In FIGS. 13B and 13G, the mobile terminal 5 that includes, as the display unit 504, a display screen (liquid crystal display or the like) having a long side and a short side is displayed as display examples in a case where the long side direction is held to be perpendicular to the ground. Two display regions (1306a and 1306b in a case of FIG. 13C) are aligned in the long side direction. Even in a case where the mobile terminal 5 is rotated by 90 degrees, similarly, two display regions (1306a and 1306b) may be aligned in the long side direction.

Since the mobile terminal 5 such as the smart phone usually has a vertical screen, the display region is disposed in the vertical direction as described above, and thereby it is possible to naturally display a plurality of display regions on the same screen. Since a case where the vertical mobile terminal 5 is laid to have a horizontal or lateral shape is considered, in this case, it is preferable that the display unit 504 is controlled such that the display regions described above are aligned in the horizontal or lateral direction. Hereinafter, the display regions are aligned in the vertical direction; however, it is also possible to apply such a configuration to a case where the display regions are aligned in the horizontal or lateral direction. Similarly, such a display method is also applied to screens 1307, 1308, 1309, and 1310 as illustrated in FIGS. 13D to 13G.

In the example of FIG. 13C, the imaging result display region 1306a and the configuration information display region b are displayed in the same screen.

Scroll bars 1306c and 1306h illustrated in FIG. 13C are used to change displayed items of the configuration information that is displayed in the configuration information display region 1306b in FIG. 13C. In other words, in a case where scroll operations are performed on the scroll bars 1306c and 1306h by the user, the mobile-terminal controller 501 controls the display unit 504 such that other items of configuration information, which are different from the configuration information items currently displayed on the configuration information display region 1306b, are displayed.

Next, when the user operates a “malfunction analysis” display region 1303 on the screen 1300 illustrated in FIG. 13B, the mobile-terminal controller 501 performs control such that the screen that displays the display unit 504 is subjected to transition to the screen 1307 as illustrated in FIG. 13D.

On the screen 1307, the user displays, in the imaging result display region 1307a, the video and the still image acquired by the mobile-terminal imaging unit 507 and controls the display unit 504 such that the malfunction analysis results are displayed on a malfunction analysis result display region 1307b.

When the user operates, on the operating unit 505, a “TOP” display region 1307d on the screen 1307, the mobile-terminal controller 501 performs control such that the display unit 504 returns to the screen 1300 in FIG. 13B.

When the user operates, on the operating unit 505, a “save” display region 1307e on the screen 1307, the mobile-terminal controller 501 generates a still image of the screen that is displayed in the imaging result display region 1307a of the screen 1307, and the mobile-terminal controller 501 causes the storage unit 506 to store the still image. At the same time, the malfunction analysis results are stored in the storage unit 506.

Scroll bars 1307c and 1307h are used to change displayed items of the malfunction analysis results that are displayed in the “malfunction analysis result” display region 1307b. In other words, in a case where scroll operations are performed on the scroll bars 1307c and 1307h by the user, the mobile-terminal controller 501 controls the display unit 504 such that other items of malfunction analysis results, other than the malfunction analysis result items currently displayed on the “malfunction analysis result” display region 1307b, are displayed.

Next, when the user operates a “repair work” display region 1304 on the screen 1300 illustrated in FIG. 13B, the mobile-terminal controller 501 performs control such that the display unit 504 is subjected to transition to the screen 1308 as illustrated in FIG. 13E.

On the screen 1308, the display unit 504 is controlled such that the video and the still image acquired by the mobile-terminal imaging unit 507 by the operation of the user is displayed in the imaging result display region 1308a, and the repair work instruction is displayed in the repair work instruction work display region 1308b.

When the user operates, on the operating unit 505, a “TOP” display region 1308d on the screen 1308, the mobile-terminal controller 501 performs control such that the display unit 504 returns to the screen 1300 in FIG. 13B.

When the user operates, on the operating unit 505, a “save” display region 1308e on the screen 1308, the mobile-terminal controller 501 generates the still image of the screen that is displayed in the imaging result display region 1308a of the screen 1308, and the mobile-terminal controller 501 causes the storage unit 506 to store the still image. At the same time, the repair work results are stored in the storage unit 506.

When the user operates, on the operating unit 505, the “next” display region 1308g on the screen 1308, the mobile-terminal controller 501 performs control such that the display unit 504 is subjected to transition to a screen 1309 in FIG. 13F.

In FIG. 13E, a repair work procedure CG 1308f, which is superimposed on the video and the still image acquired with the imaging unit 507, is displayed in the imaging result display region 1308a. The repair work procedure CG 1308f is displayed on the display unit 504 by the mobile-terminal controller 501, based on the position information of the AR marker (1301) identified with the mobile terminal 5. The repair work procedure CG 1308f shows a position of a target that is displayed in a “work instruction” display region 1308b that instructs the repair work, and it is possible for the user to perform repair work in a correct procedure following the instructions.

A scroll bar 1308c is used to change the repair work instruction that is displayed in the “work instruction” display region 1308b. In other words, in a case where scroll operations are performed on the scroll bar 1308c by the user, the mobile-terminal controller 501 controls the display unit 504 such that the repair work instruction, which is different from the repair work instruction that is currently displayed in the “work instruction” display region 1308b, is displayed.

Next, when the user operates a “next” display region 1308g on the screen 1308 illustrated in FIG. 13E, the mobile-terminal controller 501 performs control such that the display unit 504 is subjected to transition to the screen 1309 in FIG. 13F.

On the screen 1309, the display unit 504 is controlled such that the video and the still image acquired by the mobile-terminal imaging unit 507 by the operation of the user is displayed in a “work instruction” display region 1309b. In addition, the display unit 504 is controlled such that setting information on the board is displayed in a “work instruction” display region 1309h.

When the user operates, on the operating unit 505, a “previous” display region 1309d on the screen 1309, the mobile-terminal controller 501 performs control such that the display unit 504 returns to the screen 1308 in FIG. 13E.

When the user operates, on the operating unit 505, a “save” display region 1309e on the screen 1309, the mobile-terminal controller 501 generates the still image of the screen that is displayed in the imaging result display region 1309a of the screen 1309, and the mobile-terminal controller 501 causes the storage unit 506 to store the still image. At the same time, the repair work results are stored in the storage unit 506.

When the user operates, on the operating unit 505, the “next” display region 1309g on the screen 1309, the mobile-terminal controller 501 performs control such that the display unit 504 is subjected to transition to a screen 1310 in FIG. 13G.

The imaging result display region 1309a is the same as the imaging result display region 1308a described in FIG. 13E, and thus the description thereof is omitted. In addition, the “work instruction” display region 1309b, in which the repair work is instructed, is the same as the “work instruction” display region 1308b described in FIG. 13E, and thus the description thereof is omitted.

The display region 1309h is illustrated as an example of setting content of a DIP switch on a printed board that is set at the time of the repair work. When the setting of the air conditioner 100 is performed, it is difficult to acquire an image of the air conditioner 100 with the mobile terminal 5 depending on an installation location of the printed board, in some cases. At this time, it is not possible to superimpose and display the repair CG on the display region 1309a. The display region 1309h is provided and is displayed, and thereby it is possible to perform the repair work even in a case where it is difficult to acquire an image of the air conditioner 100 with the mobile terminal 5.

A scroll bar 1309i is used to change the content displayed in the display region 1309h. In other words, in a case where a scroll operation is performed on a scroll bar 1309c in the “work instruction” display region 1309b by the user, the mobile-terminal controller 501 controls the display unit 504 such that content that is different from the content that is currently displayed in the display region 1309h is displayed.

Next, when the user operates a “next” display region 1309g on the screen 1309 illustrated in FIG. 13F, the mobile-terminal controller 501 performs control such that the display unit 504 is subjected to transition to the screen 1310 in FIG. 13G.

On the screen 1310, the display unit 504 is controlled such that the video and the still image acquired by the mobile-terminal imaging unit 507 by the operation of the user is displayed in the imaging result display region 1310a, and the repair work instruction is displayed in a “work instruction” display region 1310b.

When the user operates, on the operating unit 505, a “previous” display region 1310d on the screen 1310, the mobile-terminal controller 501 performs control such that the display unit 504 returns to the screen 1308 in FIG. 13E.

When the user operates, on the operating unit 505, the “save” display region 1310e on the screen 1310, the mobile-terminal controller 501 generates the still image of the screen that is displayed in the imaging result display region 1310a of the screen 1310, and the mobile-terminal controller 501 causes the storage unit 506 to store the still image. At the same time, the repair work results are stored in the storage unit 506.

When the user operates, on the operating unit 505, a “TOP” display region 1310g on the screen 1310, the mobile-terminal controller 501 performs control such that the display unit 504 is subjected to transition to the screen 1300 in FIG. 13B.

In FIG. 13G, since 1310a, 1310b, 1310c, and 1310f, are the same as 1308a, 1308b, 1308c, and 1308f described in FIG. 13F, and thus the description thereof is omitted.

When the user operates a “report generation” display region 1305 on the screen 1300 illustrated in FIG. 13B in S823, the mobile-terminal controller 501 performs control such that the screen that displays the display unit 504 is subjected to transition to a screen 1311 as illustrated in FIG. 13H.

A report 1311a generated by the management server 9 in S826 is displayed on the screen 1311 in S831. In the report 1311a, a cause of the malfunction 13111 that is coincident with the operation information determined through the process flow as illustrated in FIG. 9 in the process step illustrated in FIG. 8, a sensor value 13112 obtained before the repair work and a sensor value 13113 obtained after the repair work that are obtained in the process flow of the repair work as illustrated in FIG. 10 in the process step S819 illustrated in FIG. 8, a repair work procedure 13114 that is generated in S819, an image 13115 obtained after the process corresponding to the repair work procedures, a total determination result 13116 of the repair work, or the like are illustrated in a list form.

As described above, when the display device is applied to the mobile terminal of the example, it is possible to perform automatic determination of the malfunction in accordance with the configuration of the air conditioner without analysis of the operation information by the user, and the repair procedures of the air conditioner are displayed to be easily understood when a malfunction occurs. Therefore, it is possible for the user to efficiently perform maintenance of the air conditioner.

In addition, since the repaired results are output in a report form, it is possible to directly check the repaired results on site of the repair work. In addition, since it is possible for the user to use the report as a written report, it is possible to save time and effort to generate the report again.

### Example 2

In the example, when the repair work of the air conditioner is performed, operations of air-conditioner maintenance system through voice input and the repair work instruction through voice output and vibration from the mobile-terminal display unit, in addition to a work instruction display on the mobile-terminal display unit, are performed.

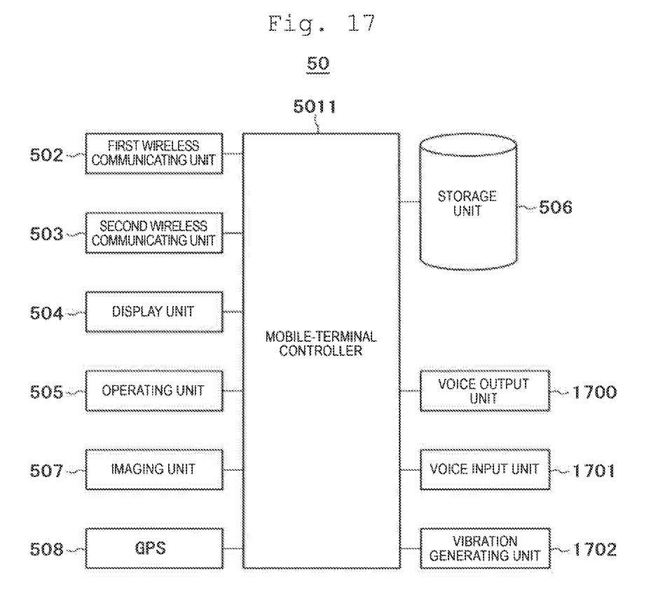

FIG. 17 is a functional block diagram of a mobile terminal 50 as the display device of the example. In FIG. 17, the same reference signs are assigned to the same components as those in the mobile terminal 5 as the display device of Example 1, and the description thereof is omitted.

The mobile terminal 50 further includes a voice output unit 1700, a voice input unit 1701, and a vibration generating unit 1702, in addition to replacement of the mobile-terminal controller 501 with a mobile-terminal controller 5011 in the configuration of the mobile terminal 5.

In addition, a sequence that performs the automatic determination result and the repair procedure display in the malfunction of the air conditioner in the example is different from the sequence of Example 1 described with reference to FIG. 8 in that processes of S801, S809, S816, and S823 are different. In other words, the mobile-terminal controller 201 performs various operations by acquiring a voice produced by the user with the voice input unit 1701 provided in the mobile terminal 50, analyzing the voice in the mobile-terminal controller 5011, and controlling of transmitting Steps S803, S810, S817, and S824.

In addition, according to the example, in the sequence of Example 1 described with reference to FIG. 8, the display unit 504 is controlled to display the repair work procedure acquired from the management server 9 in S822, and control is performed such that the vibration generating unit 1702 is caused to vibrate, the acquired repair work procedure is converted into voice information in the mobile-terminal controller 5011, and the voice information is output from the voice output unit 1700.

As described above, in the example, it is possible to perform the operation from the voice input unit 1701 in addition to the operation on the operating unit 505, and thereby it is possible to perform operation without directly operating the mobile terminal by hand. In addition, the repair work procedure is output in a voice from the voice output unit 1700, vibration is generated in the vibration generating unit 1702, and thereby it is possible to perform the repair work without directly watching the mobile terminal.

Note that the invention is not limited to the examples described above, and the invention may include various modification examples. For example, the examples described above are described in detail for easy understanding of the invention, and the invention is not necessarily limited to the example including the entire configurations in the description. In addition, it is possible to replace some configurations in a certain example with configurations in another example, and it is also possible to add a configuration in one example to a configuration in another example. In addition, it is possible to perform addition, removal, and replacement of another configuration to, from, and with some configurations in the examples.

In addition, a part or all of the configurations, the functions, the processing units, the processing means, or the like described above may be realized by hardware with a design of an integrated circuit or the like. In addition, the configurations, the functions, or the like described above may be realized by software by analyzing and executing a program that causes a processor to realize the functions thereof. Information of a program, a table, a file, or the like that realizes the functions can be mounted on a recording device such as a memory, a hard disk, a solid state drive (SSD), or the like, or on a recording medium such as an IC card, an SD card, a DVD, or the like.

In addition, control lines or information lines which are considered to be necessary for the description are illustrated, and it is not necessary to illustrate all of the control lines and information lines of a product. Actually, almost all of the configurations may be considered to be connected to each other.

### INDUSTRIAL APPLICABILITY

According to the present invention, in the trial operation, the maintenance, or the like of the air conditioner, it is possible to easily identify configuration information and the malfunction of the air conditioner, and it is possible to provide the information terminal with which the repair work is easily performed.

### REFERENCE SIGNS LIST

1: outdoor device
2: indoor device
3: central control device
4: wireless adapter
5: mobile terminal
6: air-conditioner communicating transmission line
7: wide-area wireless communication base station
8: internet
9: management server
10: information terminal
11: printer
12: remote control
101: compressor
102: four-way valve
103: outdoor heat exchanger
104: outdoor fan
105: outdoor expansion valve
201: indoor heat exchanger
202: indoor fan
203: indoor expansion valve
31: gas piping
32: liquid piping
41: outside-air temperature sensor
42: compressor-discharge-gas-piping temperature sensor
43: heat-exchanger-piping temperature sensor
44: inlet temperature sensor
45: outlet temperature sensor
46: refrigerant-gas-piping temperature sensor
47: refrigerant-liquid-piping temperature sensor
48: remote-control temperature sensor
51: high-pressure sensor
52: low-pressure sensor

1. A maintenance system of an air conditioner that is provided with an indoor device, an outdoor device, a control device, and a wireless adapter, the system comprising:
a mobile terminal that intercommunicates with the wireless adapter; and
a management server that is connected to the wireless adapter and the mobile terminal via a communication line,
wherein the mobile terminal transmits information related to an operating state of the air conditioner to the management server via the wireless adapter and acquires repair work procedure information of a malfunction part in an operation from the management server, and
wherein the mobile terminal transmits, to the management server, results of repair on the air conditioner that is performed, based on the acquired repair work procedure information and acquires work report information from the management server.

2. The maintenance system of an air conditioner according to claim 1,
wherein the mobile terminal acquires, as the repair work procedure information of the malfunction part in the operation of the air conditioner that is acquired from the management server, work procedures, work content for each work procedure, and detailed information on work content and displays the information on a screen of the mobile terminal.

3. The maintenance system of an air conditioner according to claim 1,
wherein the mobile terminal acquires, as the repair work procedure information of the malfunction part in the operation of the air conditioner that is acquired from the management server, computer graphics (CG) information that indicates the repair work procedure, and displays the information on a screen of the mobile terminal.

4. The maintenance system of an air conditioner according to claim 1,
wherein the mobile terminal
transmits an image of the air conditioner to the management server and acquires information related to a configuration of the air conditioner from the management server,
transmits, to the management server, information related to the operating state of the air conditioner that is associated with the acquired information related to the configuration of the air conditioner, and
receives determination results of the operating state of the air conditioner that is determined, based on the transmitted information related to the operating state of the air conditioner in the management server and acquires repair work procedure information of the malfunction part in the operation from the management server.

5. The maintenance system of an air conditioner according to claim 4,
wherein the mobile terminal transmits, as the image of the air conditioner, to the management server, an image containing information that is used to identify the air conditioner.

6. The maintenance system of an air conditioner according to claim 1,
wherein the mobile terminal has, as the information related to the operating state of the air conditioner, any one of an operation frequency, high-pressure side pressure, low-pressure side pressure, a primary current and a secondary current of an inverter, and an outside temperature of a compressor of the outdoor device of the air conditioner, a total of operation frequencies of a plurality of compressors, an inlet air temperature, an outlet air temperature, a temperature difference between the inlet air temperature and the outlet air temperature, a preset temperature, an operation mode, and a preset air volume of the indoor device of the air conditioner.

7. A maintenance method of an air conditioner that is provided with an indoor device, an outdoor device, a control device, and a wireless adapter, the method comprising:
transmitting information related to an operating state of the air conditioner from a mobile terminal via the wireless adapter to a management server connected through a communication line;
acquiring, by the mobile terminal, repair work procedure information of a malfunction part in an operation of the air conditioner from the management server that receives the information related to the operating state of the air conditioner;
transmitting, from the mobile terminal to the management server, results of repair on the air conditioner that is performed, based on the repair work procedure information acquired in the mobile terminal; and
acquiring, by the mobile terminal, work report information from the server that receives the repair results of the air conditioner.

8. The maintenance method of an air conditioner according to claim 7,
wherein the mobile terminal acquires, as the repair work procedure information of the malfunction part in the operation of the air conditioner that is acquired from the management server, work procedures, work content for each work procedure, and detailed information on work content and displays the information on a screen of the mobile terminal.

9. The maintenance method of an air conditioner according to claim 7,
wherein the mobile terminal acquires, as the repair work procedure information of the malfunction part in the operation of the air conditioner that is acquired from the management server, computer graphics (CG) information that indicates the repair work procedure, and displays the information on a screen of the mobile terminal.

10. The maintenance method of an air conditioner according to claim 7,
wherein the mobile terminal
transmits an image of the air conditioner to the management server and acquires information related to a configuration of the air conditioner from the management server,
transmits, to the management server, information related to the operating state of the air conditioner that is associated with the acquired information related to the configuration of the air conditioner, and
receives determination results of the operating state of the air conditioner that is determined, based on the transmitted information related to the operating state of the air conditioner in the management server and acquires repair work procedure information of the malfunction part in the operation from the management server.

11. The maintenance method of an air conditioner according to claim 10,
wherein the mobile terminal transmits, to the management server, as the image of the air conditioner, an image containing information that is used to identify the air conditioner.

12. The maintenance method of an air conditioner according to claim 7,
wherein the mobile terminal has, as the information related to the operating state of the air conditioner, any one of an operation frequency, high-pressure side pressure, low-pressure side pressure, a primary current and a secondary current of an inverter, and an outside temperature of a compressor of the outdoor device of the air conditioner, a total of operation frequencies of a plurality of compressors, an inlet air temperature, an outlet air temperature, a temperature difference between the inlet air temperature and the outlet air temperature, a preset temperature, an operation mode, and a preset air volume of the indoor device of the air conditioner.
